(19) United States
(12) Patent Application Publication
(10) Pub. No.: US 2010/0251990 A1
(43) Pub. Date: Oct. 7, 2010

(54) Engine

(76) Inventor: Kenneth McDonald, Leeds Yorkshire (GB)

Correspondence Address: DOWNS RACHLIN MARTIN PLLC, 199 MAIN STREET, P O BOX 190, BURLINGTON, VT, 05402-0190, US

(21) Appl. No.: 12/669,150

(22) PCT Filed: Jul. 16, 2008
(86) PCT No.: PCT/GB08/50575

§ 371 Date: Jun. 17, 2010

(30) Foreign Application Priority Data
Jul. 16, 2007 (GB) 0713755.7
Apr. 1, 2008 (GB) 0805899.2

(51) Int. Cl. F02B 53/00

(52) U.S. Cl. 123/200

(57) ABSTRACT

An engine comprising a first section having a first face and a second section having a second face, the first and second faces being opposed to one another and arranged for relative rotation, the first face comprising at least one chamber, the second face comprising a plurality of discrete regions each being associated with a discrete stage of a combustion cycle, wherein the first and second faces are arranged such that relative rotation thereof causes the at least one chamber of the first face to be exposed to the discrete regions of the second face.

The present invention relates to an engine, particularly, although not exclusively, to an internal combustion engine.

Engines are used in a wide variety of technical fields and in every day life. A common type of engine is an internal combustion engine. Typically, internal combustion engines comprise a plurality of combustion chambers in which fuel, such as petrol and air, is combusted. Perhaps the best known internal combustion engine has cylinders having combustion chambers in which combustion takes place. Combustion within the combustion chamber causes reciprocating movement of a piston within the cylinder which in turn causes rotational movement of an output shaft. Such engines have been the subject of much research and improvement over the last century, but are still very heavy, complicated pieces of machinery.

Also, such engines have a fundamental problem in that they require each piston to move backwards and forwards and therefore each piston must change direction and thus expend energy in each cycle.

An alternative engine known in the art is a rotary engine. The most common type of rotary engine is a Wankel rotary engine. A Wankel rotary engine comprises a fixed casing with the internal shape of a wide-waisted figure of eight, and a near triangular rotor. The rotor revolves eccentrically within the casing in such a way that the three rotor tips are continually in contact with the internal wall of the casing. Between the three sides of the rotor and the casing are three spaces (chambers), each of which alternately expands and contracts in size as the rotor “orbits”. The casing is provided with a spark plug, an inlet port and an exhaust port which are uncovered, in sequence, as the rotor revolves.

A major problem with the Wankel rotary engine is that each chamber, which is constantly being redefined as the rotor rotates, needs to be sealed from the others. This requires the rotor tips to be serviced and replaced at regular intervals, which is a major task requiring the engine to be almost completely dismantled and reassembled.

It is an object of the present invention to address the above mentioned or other problems.

According to the first aspect of the present invention there is provided an engine comprising a first section having a first face and a second section having a second face, the first and second faces being opposed to one another and arranged for relative rotation,
the first face comprising at least one chamber,
the second face comprising a plurality of discrete regions each being associated with a discrete stage of a combustion cycle, wherein
   the first and second faces are arranged such that relative rotation thereof causes the at least one chamber of the first face to be exposed to the discrete regions of the second face.

Preferably, the first and second faces are arranged such that relative rotation thereof causes the at least one chamber of the first face to have fluid contact with the discrete regions of the second face. Preferably, the two faces are arranged such that relative rotation thereof causes the at least one chamber of the first face to be exposed to the discrete regions of the second face in such an order that a combustion cycle may be completed.

Preferably, relative rotation of the two faces enables a combustion cycle to take place. Preferably, continuous relative rotation of the two faces enables a plurality of combustion cycles to take place.

It should be appreciated by a person skilled in the art that the invention may be used to carry out combustion cycles, which, by their cyclical nature, may be continuously repeated.

In one embodiment of the invention, each of the plurality of discrete regions may include any one of the following: a first fuel inlet region; a second fuel inlet region; a third fuel inlet region; a compression region; an ignition region; an exhaust region.

In a particularly preferred embodiment, the second face comprises at least one fuel inlet region, at least one ignition region and at least one exhaust region, and, preferably, the two faces are arranged such that relative rotation thereof causes the at least one chamber of the first face to be exposed to the discrete regions of the second face in the order: fuel inlet followed by ignition followed by exhaust.

For the avoidance of doubt, since the engine follows a combustion “cycle”, it should be appreciated that, because of the cyclical nature, it is unimportant which of the three regions (mentioned above) the chamber is exposed to first, as long as the overall order remains the same. For example, fuel inlet followed by ignition followed by exhaust is considered equivalent to exhaust followed by fuel inlet followed by ignition which is considered equivalent to ignition followed by exhaust followed by fuel inlet.

Preferably, the first face is adapted to rotate relative to the second face, which second face is preferably, generally fixed relative to the engine. Preferably, the discrete regions associated with discrete stages of a combustion cycle are arranged in a generally circular path. Preferably, the generally circular path has a radius “r” which is generally equal to the distance between the at least one chamber and the axis of rotation of the first face. In this manner, the first face is preferably adapted to rotate relative to a stationary second face and preferably, the at least one chamber is arranged to follow a generally circular path which corresponds to the generally circular arrangement of the discrete regions associated with discrete stages of a combustion cycle.

Preferably, the first face is contained on a face of a wheel, which wheel is the first section.

Preferably, the second face is contained on a face of a wall, which wall is the second section

Preferably, one of the first or second face comprises a generally circular groove and, preferably, the other of the first or second face comprises at least one socket, which at least one socket is, preferably, adapted to allow rolling means to be housed therein, which rolling means may comprise a ball. Preferably, the at least one socket is adapted to house about half of the rolling means. Preferably, the at least one socket is hemispherical. Preferably, a portion of the rolling means protrudes from the face which comprises the at least one socket, preferably, about half of the rolling means protrudes therefrom. Preferably, the circular groove is adapted to allow a portion of the rolling means to be accommodated therein. Preferably, the circular groove is adapted to allow about half of the rolling means to be accommodated therein. Preferably, the rolling means are operable to roll within the circular groove while the two faces rotate relative to each other.

Advantageously and preferably, the ball, socket and groove arrangement between the first and second faces facilitates the smooth relative rotation of the first and second face.

Preferably, the circular groove or the at least one socket comprises lubrication means. Preferably, the rolling means is lubricated.

Preferably, the or each at least one socket comprises lubrication delivery means, which lubrication delivery means may comprise lubricant guiding means. In a preferred embodiment, a lubricant may be administered through the lubricant guiding means to the rolling means. The lubrication delivery means may comprise means to urge lubricant onto the rolling means, which may comprise, for example, a spring. The lubricant guiding means may comprise means to urge lubricant onto the rolling means which may be, for example, a spring.

Preferably, the first fuel inlet region comprises means to allow a first fuel to enter the at least one chamber. Preferably, the first fuel inlet region comprises at least one aperture which preferably extends through the second face. Preferably, the first fuel inlet region comprises an arcuate inlet. Preferably, the arcuate inlet has a radius generally equal to the distance between the at least one chamber and the axis of rotation of the first face. Preferably, the arcuate inlet extends at least 10% of the generally circular path that the at least one chamber is arranged to follow, more preferably at least 15%, most preferably at least 20%. Preferably, the first fuel inlet is a gas inlet, preferably comprising means to allow gas, which may be air, to enter the at least one chamber.

In one embodiment, the first fuel inlet region may contain means to force a first fuel into the at least one chamber such as, for example, an injector, a fan, a turbo, a supercharger or the like.

In one embodiment, the engine may further comprise a reciprocating rotor operable to force a first fuel into the first fuel inlet region. The reciprocating rotor may comprise a rotor operable to rotate and reciprocate within a cylinder. The rotor may have a generally constant thickness. The rotor may be mounted on a shaft. The shaft may comprise at least one axially extending slot and preferably, a plurality of axially extending slots. Preferably, the or each axially extending slots allow axial movement of the rotor with respect to the shaft. Preferably, the or each axially extending slots prevent rotational movement of the rotor with respect to the shaft. The rotor may have at least one undulating face.

Preferably, the at least one ignition region comprises at least one means to ignite fuel that may be situated in the at least one chamber. In one embodiment the ignition region may comprise at least one means to generate an electricity discharge, such as, for example, a spark plug or a plurality of spark plugs. Where a plurality of ignition means are employed these may be controlled with reference to the speed of relative rotation of the first and second face.

Preferably, the at least one exhaust region comprises means to allow at least some of the products of combustion to exit the at least one chamber. Preferably, the exhaust region comprises an outlet, which outlet, preferably, extends through the second face. Preferably, the exhaust region comprises an arcuate outlet. Preferably, the arcuate outlet has a radius generally equal to the distance between the at least one chamber and the axis of rotation of the first face. Preferably, the arcuate outlet extends at least 20% of the generally circular path which the at least one chamber is arranged to follow, more preferably at least 30%, more preferably at least 40%, most preferably greater than about 50%. Preferably, the at least one exhaust region is a gas exhaust region, which gas exhaust region, preferably, comprises means to allow gas to exit the at least one chamber.

Preferably, the second fuel inlet region comprises means to allow a second fuel to enter the at least one chamber. The second fuel inlet region may comprise means to inject a second fuel into the at least one chamber. Preferably, the second fuel comprises a fossil fuel such as petrol, diesel etc. Alternatively, the second fuel may comprise any fuel which may be combustable under suitable temperature and pressure conditions such as, for example, hydrogen, methane, biomass.

In one embodiment, a third fuel inlet region may be present, which may be used to add a third fuel. Fluorine may be added to the combustion chamber as a fuel or as an ignition promoter, preferably where hydrogen is used as the first or second fuel. Fluorine may be added via the third fuel inlet region.

Preferably, the first face is generally circular and, preferably, the second face is generally circular. Preferably, the first and second faces are generally coaxial.

Preferably, the at least one chamber is a combustion chamber. Preferably, the engine is a combustion engine, more preferably, an internal combustion engine.

The engine may be started using electromagnetic means.

According to a second aspect of the present invention there is provided a machine or vehicle comprising an engine according to the first aspect.

According to a third aspect of the present invention there is provided an engine having a rotor with at least one combustion chamber, wherein the rotor is adapted to rotate with respect to a body section, said body section providing, in use, discrete regions for performing stages of a combustion cycle in cooperation with the rotor.

According to a further aspect of the present invention there is provided a carburettor as described herein.

According to a further aspect of the present invention, there is provided a compressor as described herein.

According to a further aspect of the present invention there is provided an exhaust system as described herein.

Accordingly to a further aspect of the present invention there is provided a tank as described herein.

All of the features contained herein may be combined with any of the above aspects in any combination.

For a better understanding of the invention, and to show how embodiments of the same may be carried into effect, reference will now be made, by way of example, to the accompanying diagrammatic drawings in which:

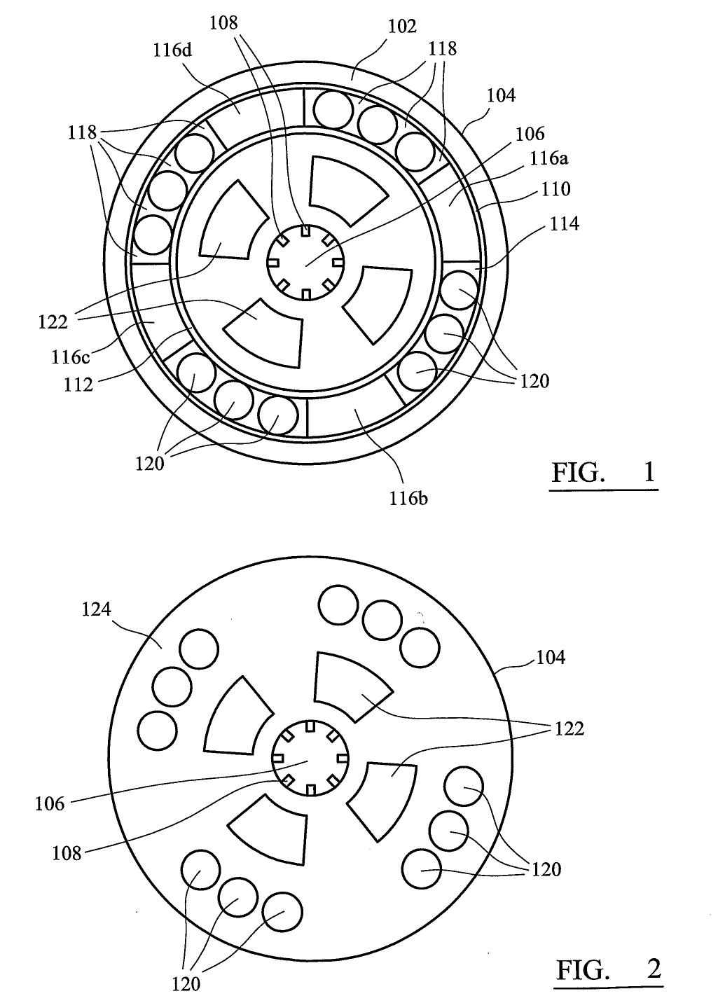

FIG. 1 shows a plan schematic view of a front face of a wheel of an engine;

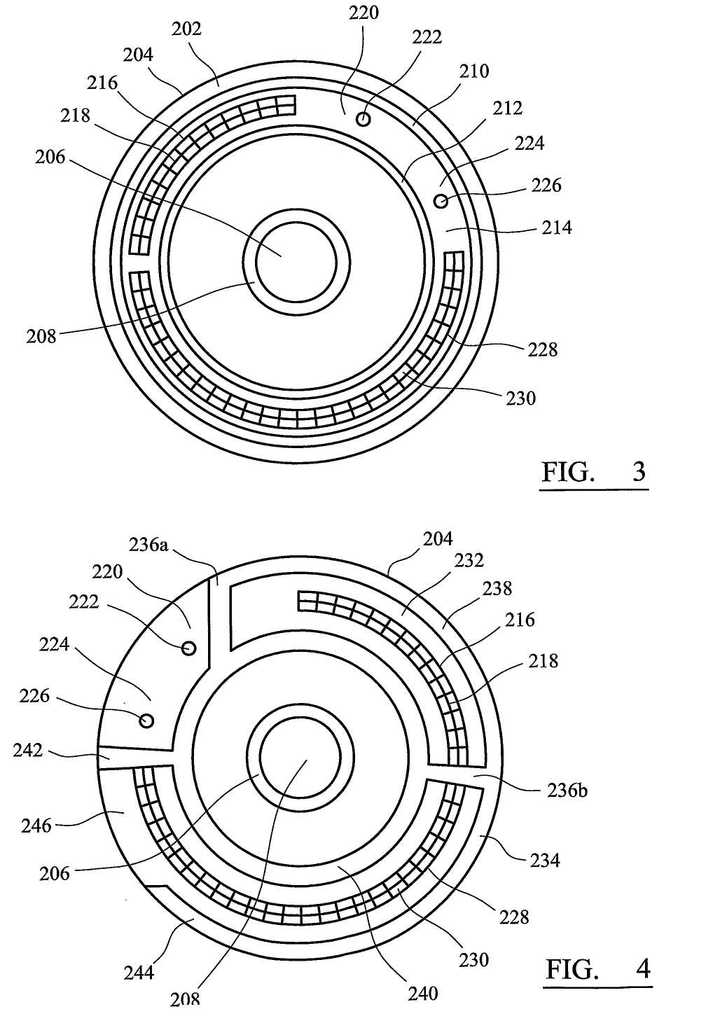

FIG. 2 shows a plan schematic view of a rear face of the wheel;

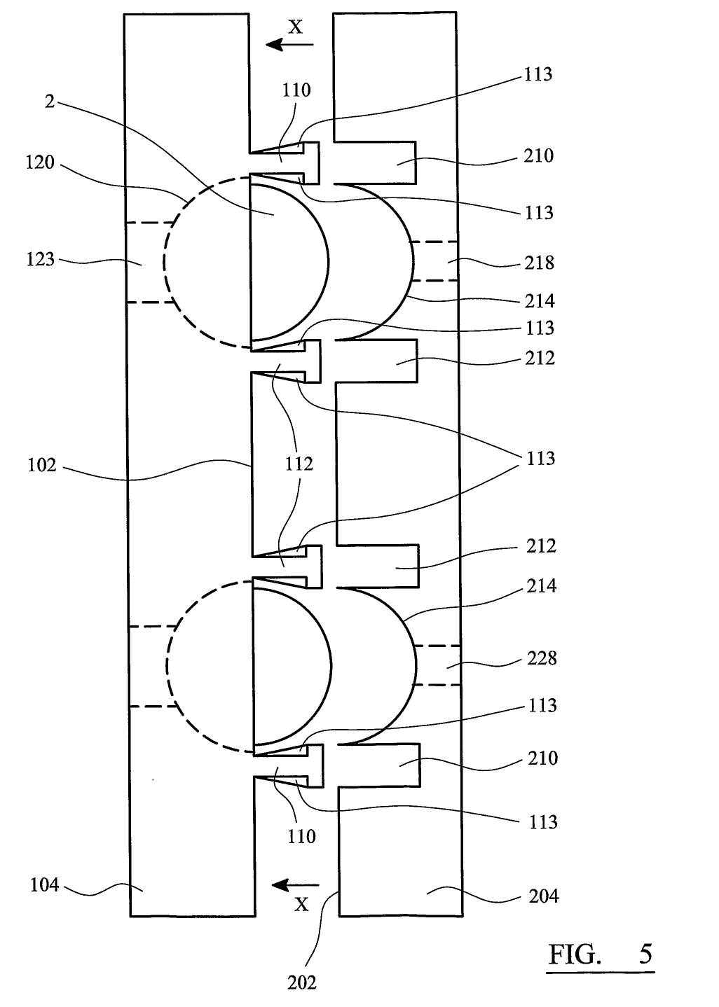

FIG. 3 shows a plan schematic view of a front face of a wall of an engine;

FIG. 4 shows a plan schematic view of a rear face of the wall;

FIG. 5 shows a sectional partially exploded schematic view of the wheel and the wall assembled together;

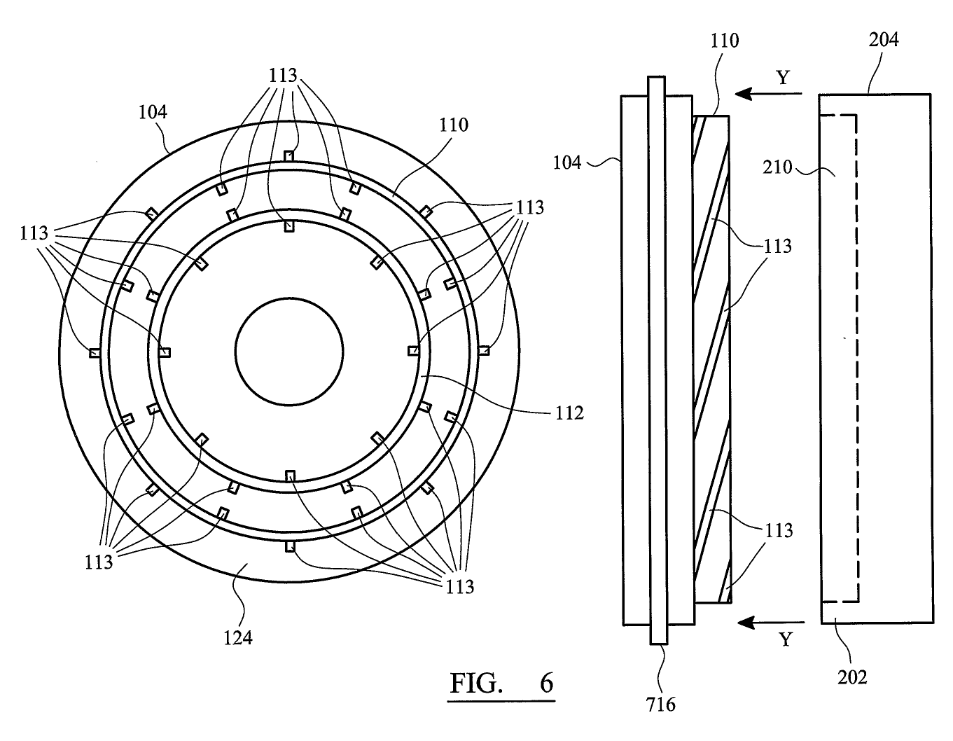

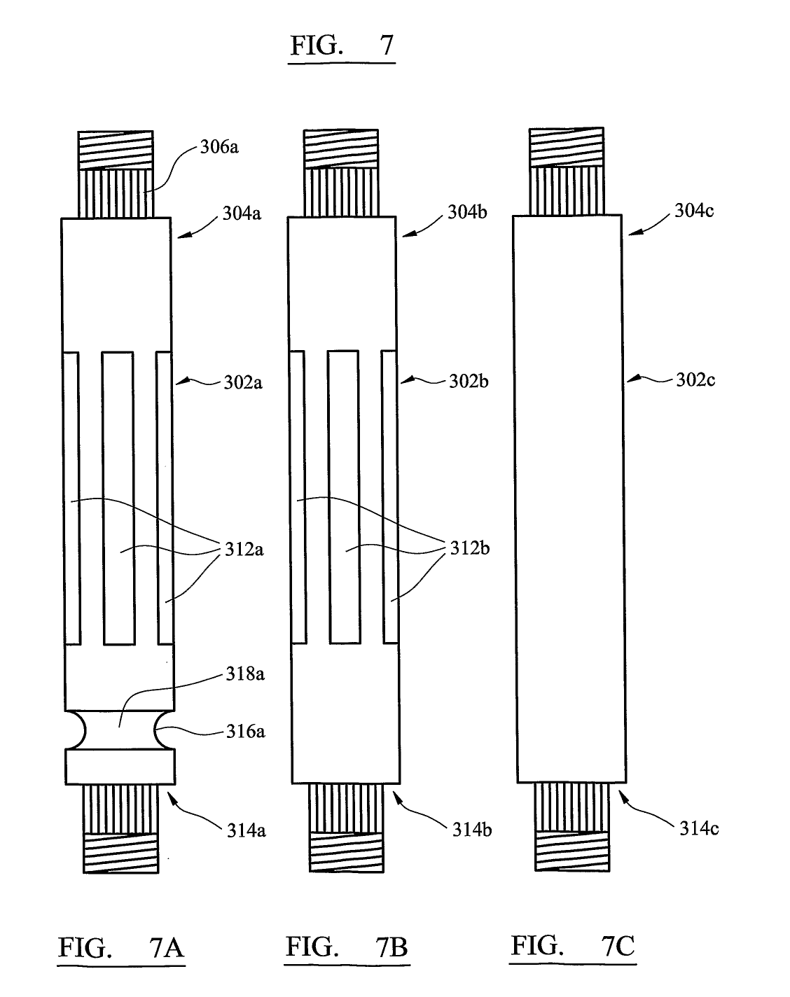

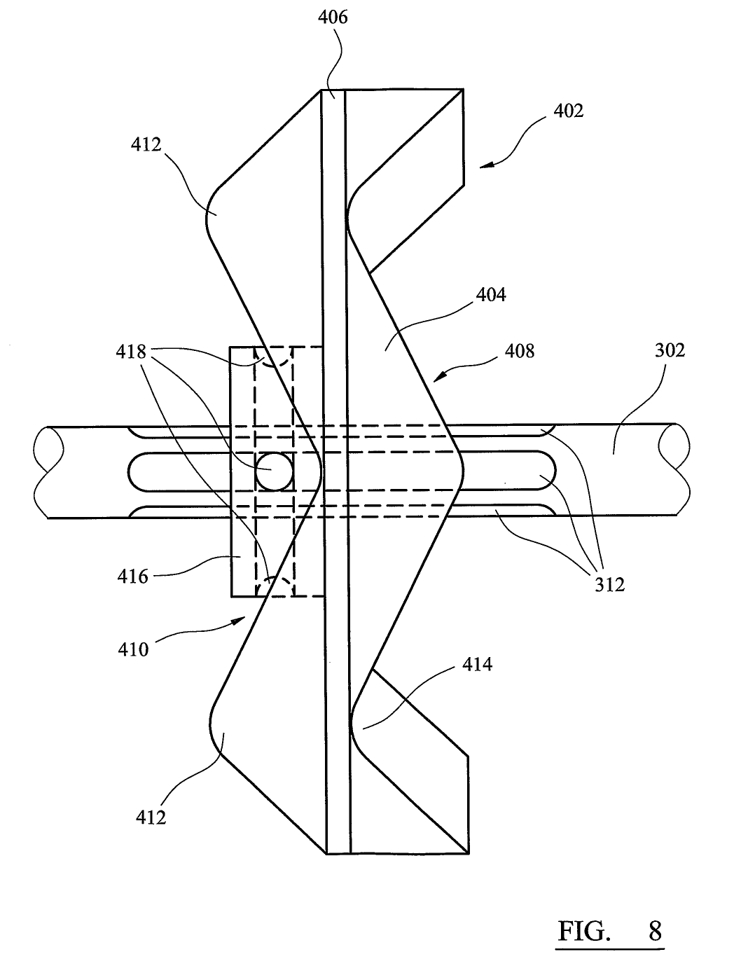

FIG. 6 shows a side partially exploded schematic view of the wheel and the wall assembled together;

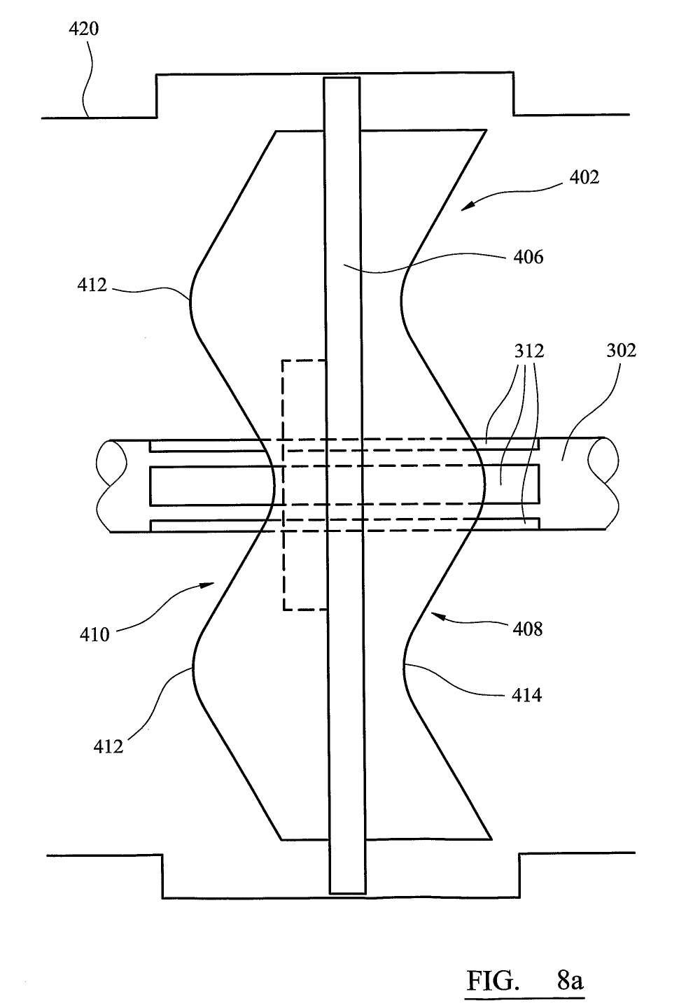

FIGS. 7a, b and c show schematic plan views of a first, second and third embodiments of shafts of the engine;

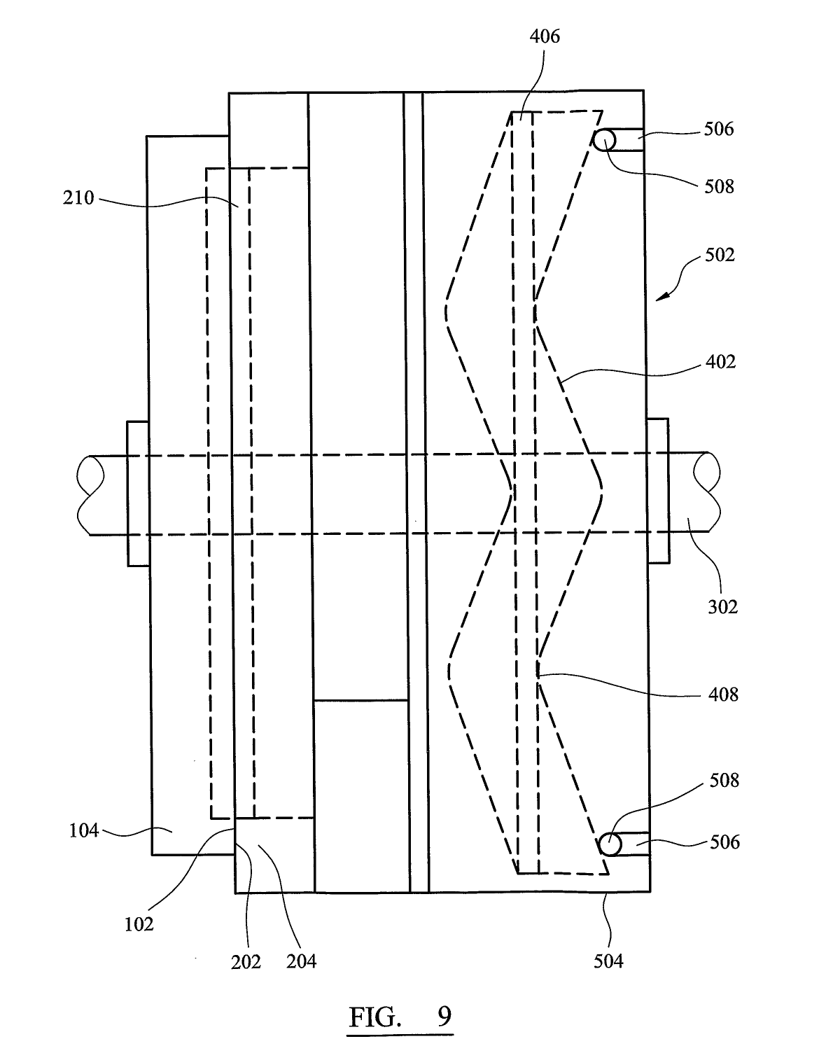

FIG. 8 shows a schematic side view of a reciprocating rotor of the engine;

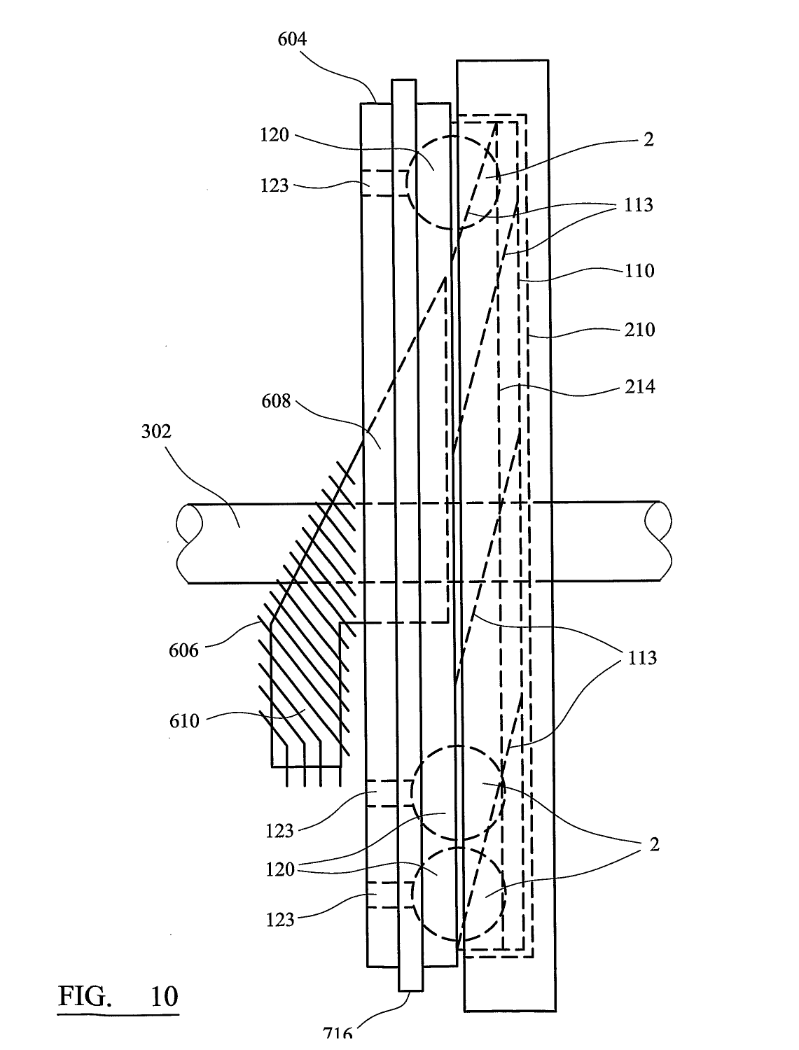

FIG. 9 shows a side partial cutaway view of the engine;

FIG. 10 shows a sectional schematic view of an alternative embodiment of a wheel of the engine;

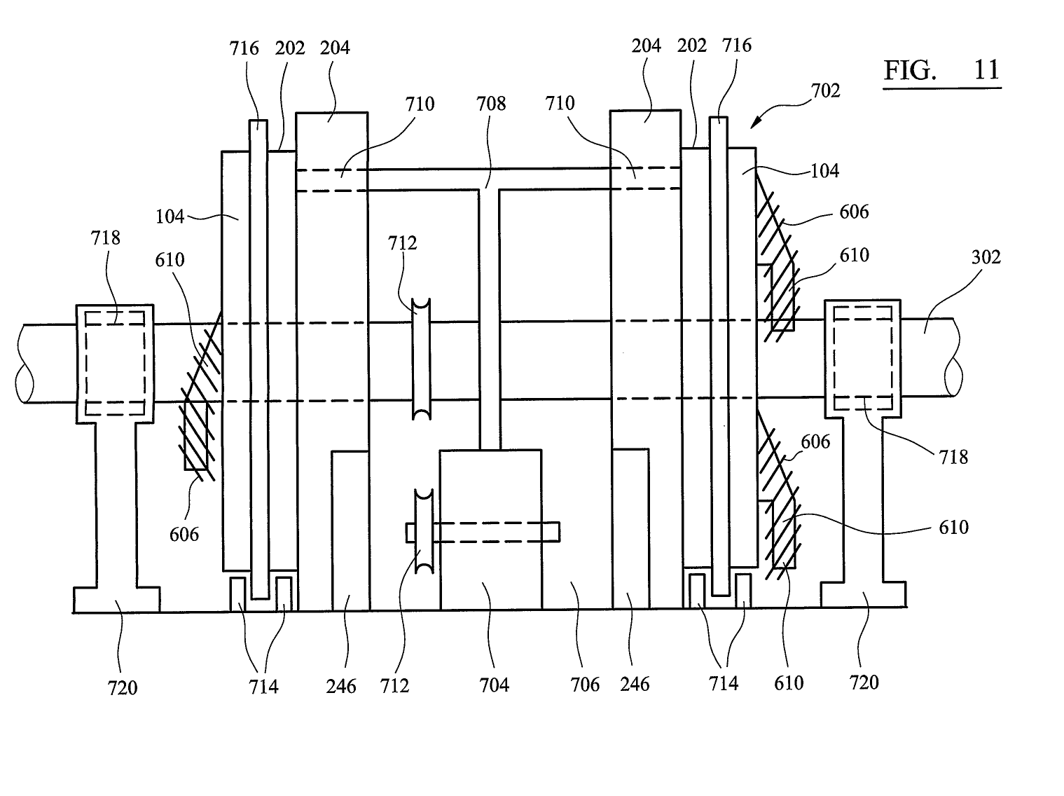

FIG. 11 shows a side partial cutaway view of a second embodiment of an engine;

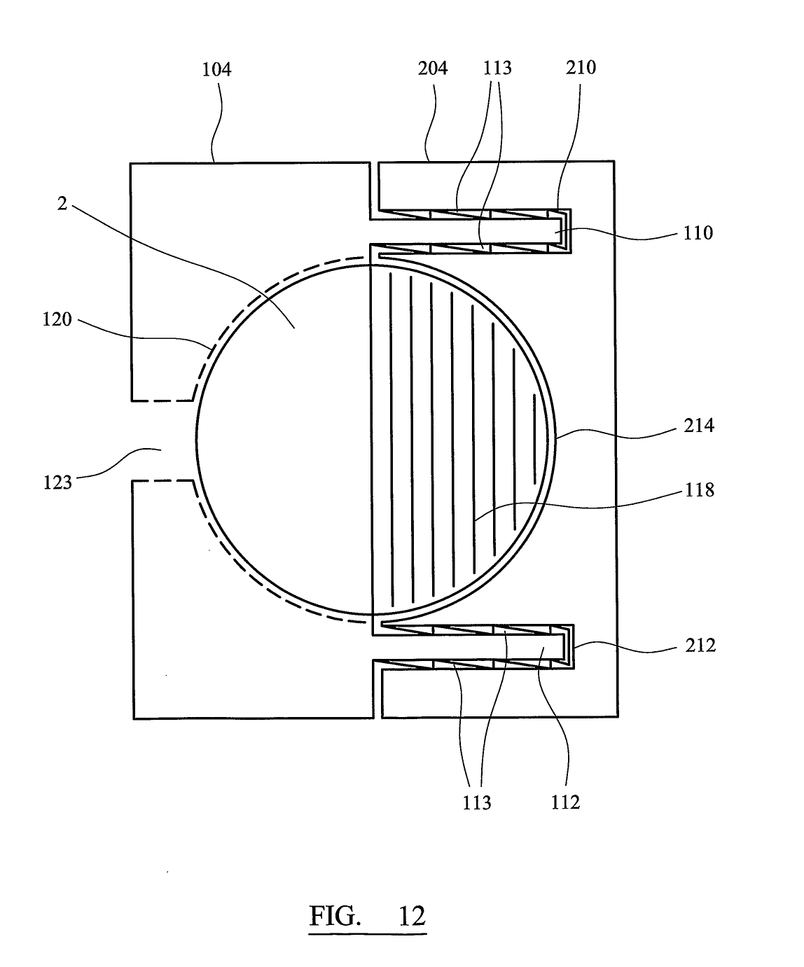

FIG. 12 shows an enlarged cross sectional view of part of the engine;

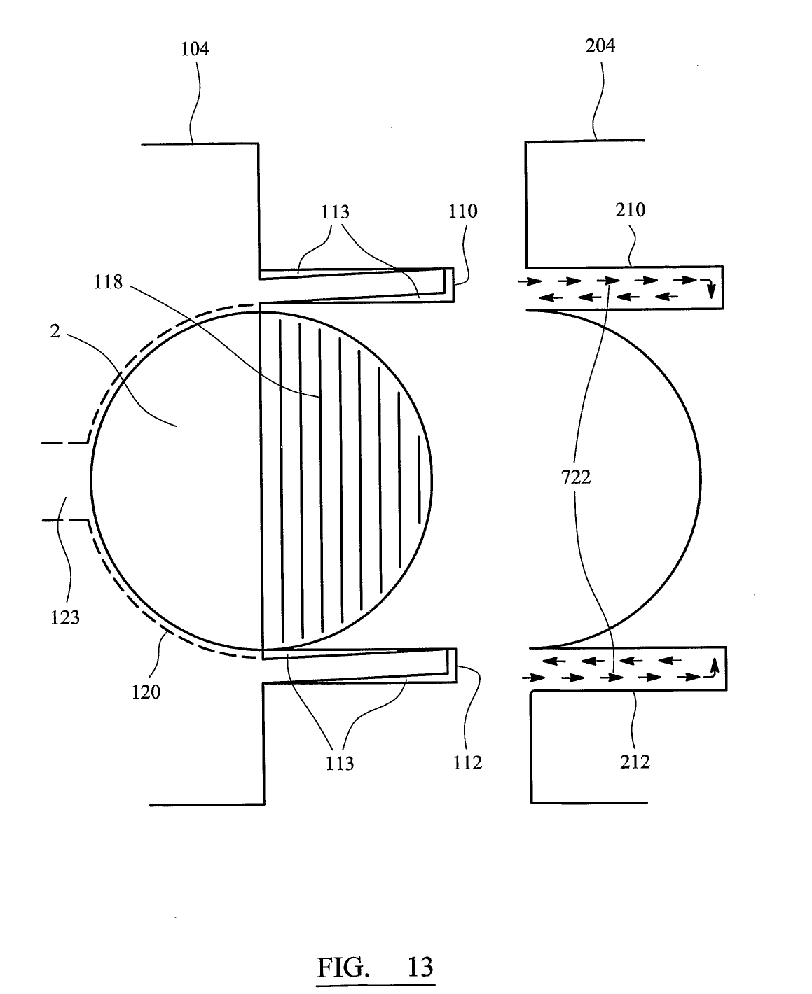

FIG. 13 shows an enlarged partially exploded view of part of the engine;

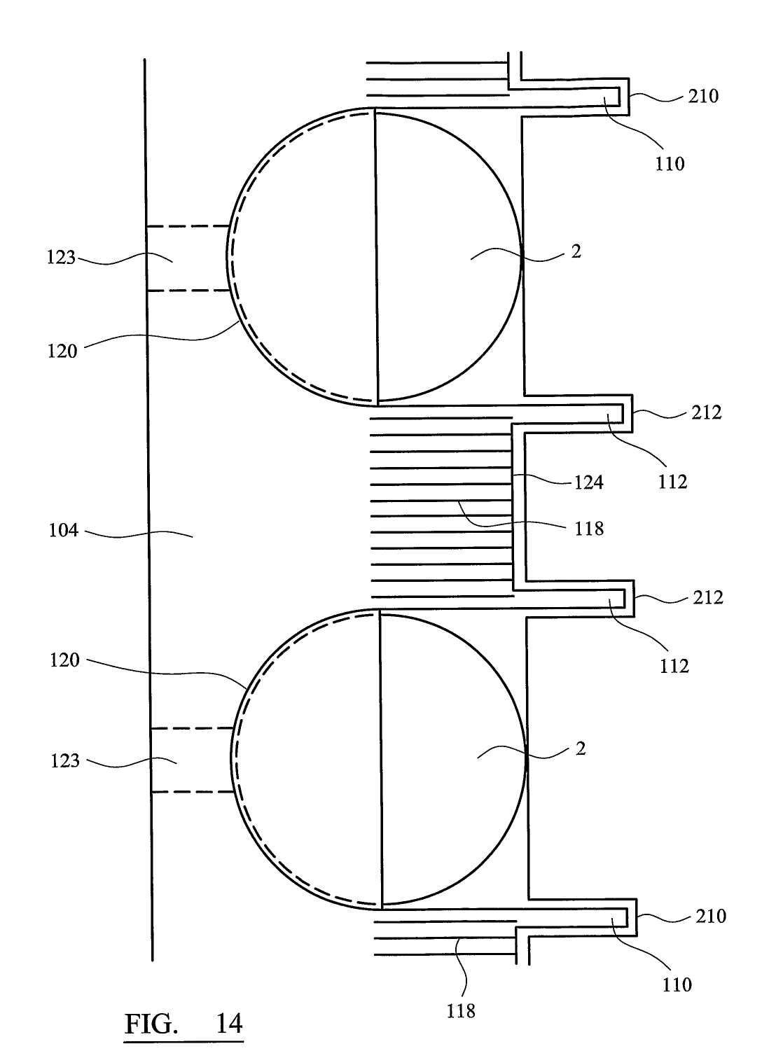

FIG. 14 shows an enlarged plan view of a part of the engine;

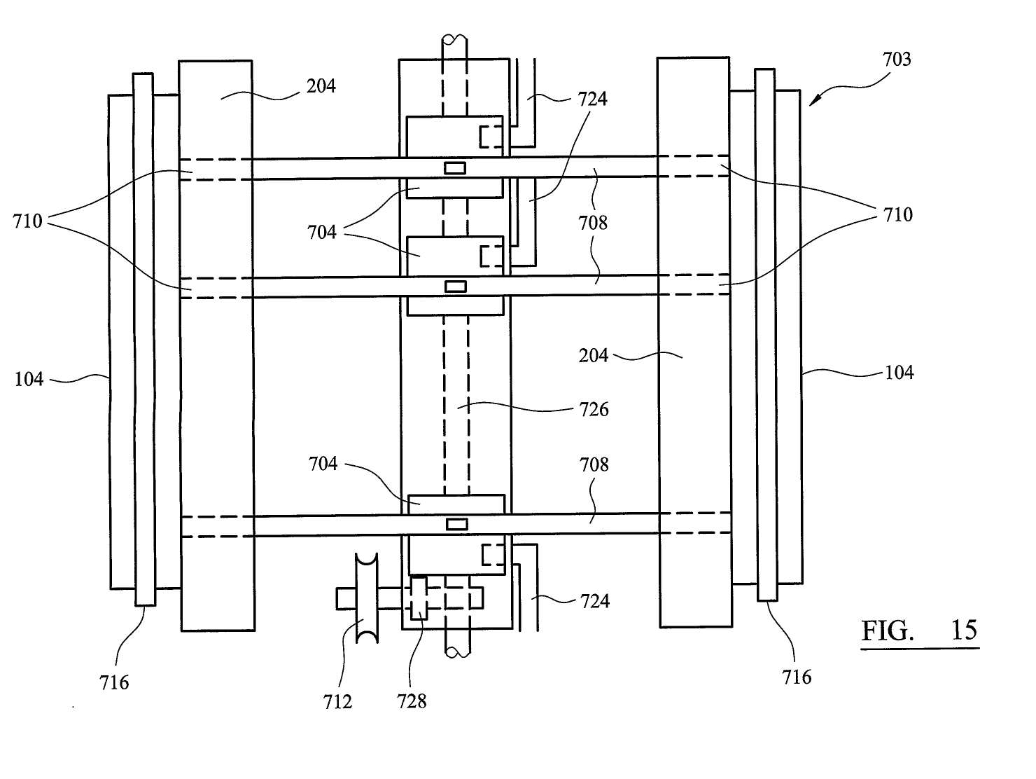

FIG. 15 shows a plan view of a further embodiment of the engine;

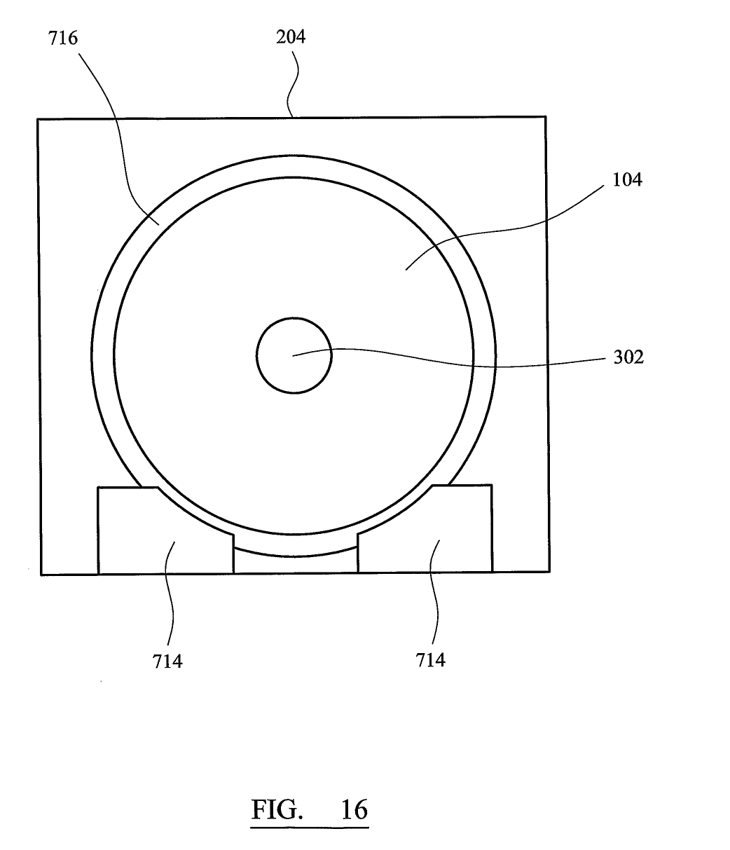

FIG. 16 shows a simplified side view of the engine showing the staring mechanism;

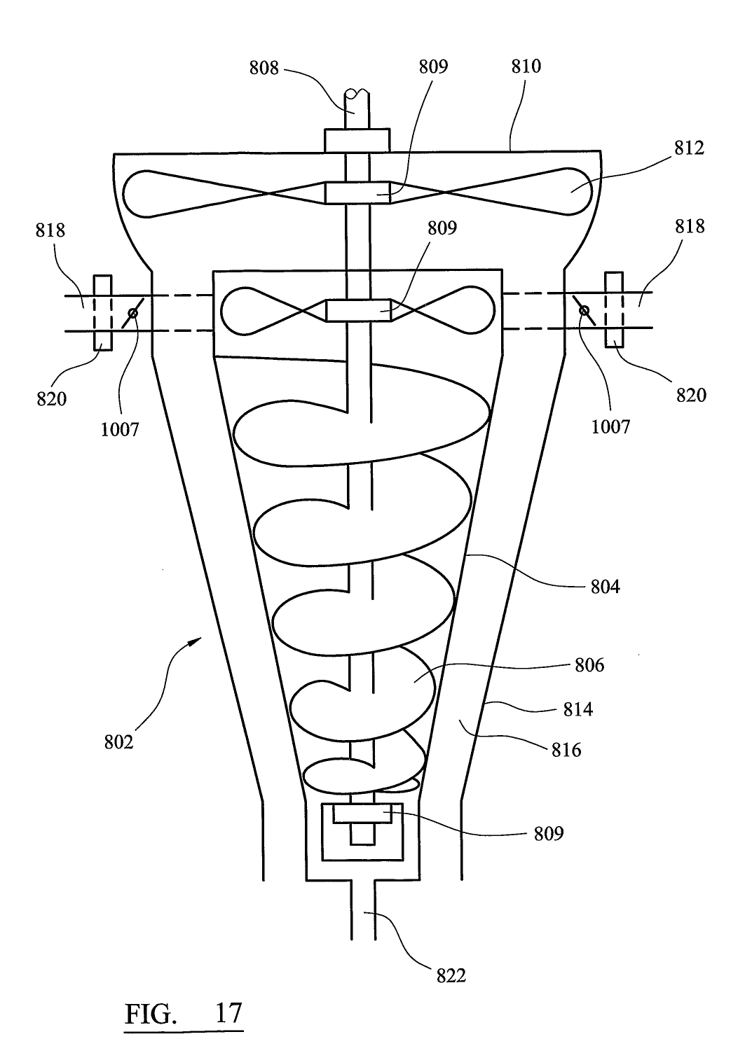

FIG. 17 shows a cross sectional view of a compressor for use with the engine;

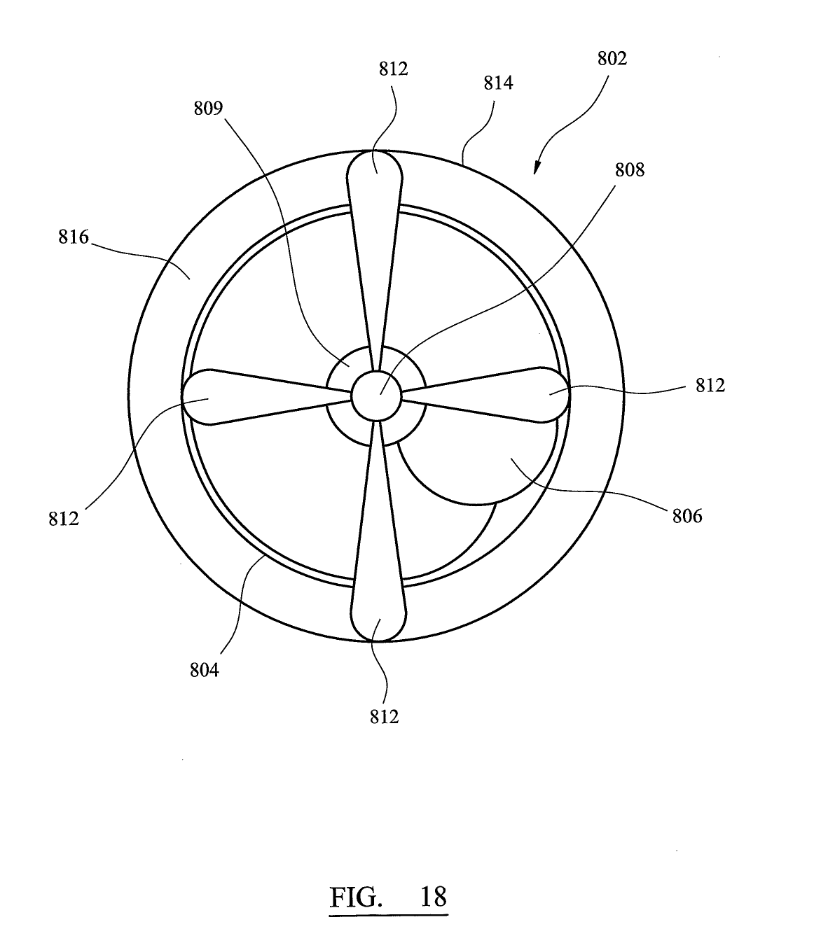

FIG. 18 shows a plan view of the compressor of FIG. 17;

FIG. 19 shows a schematic view of an exhaust system of the engine;

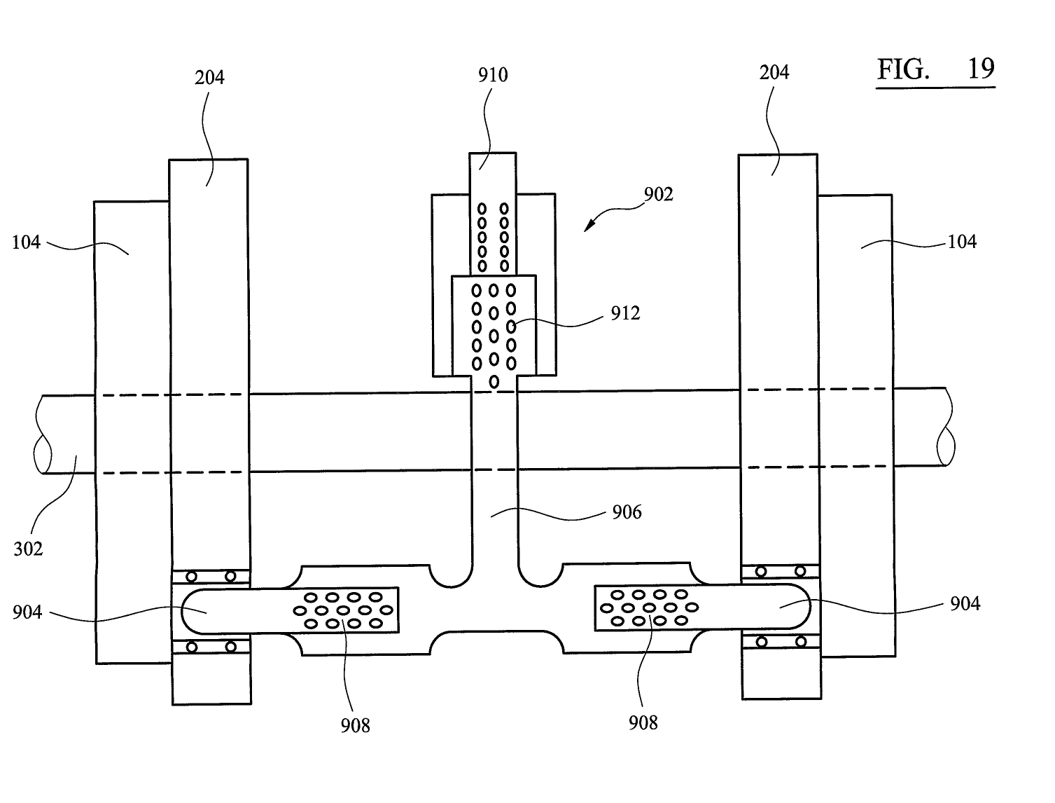

FIG. 20 shows a first embodiment of a carburettor system of the engine;

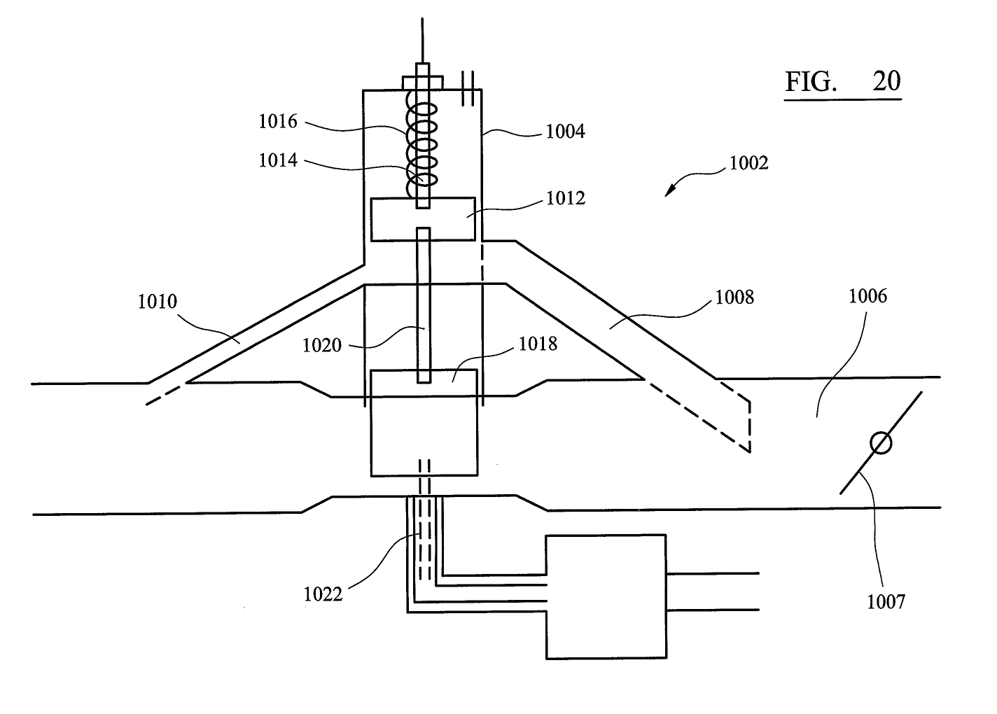

FIG. 21 shows a second embodiment of a carburettor system of the engine;

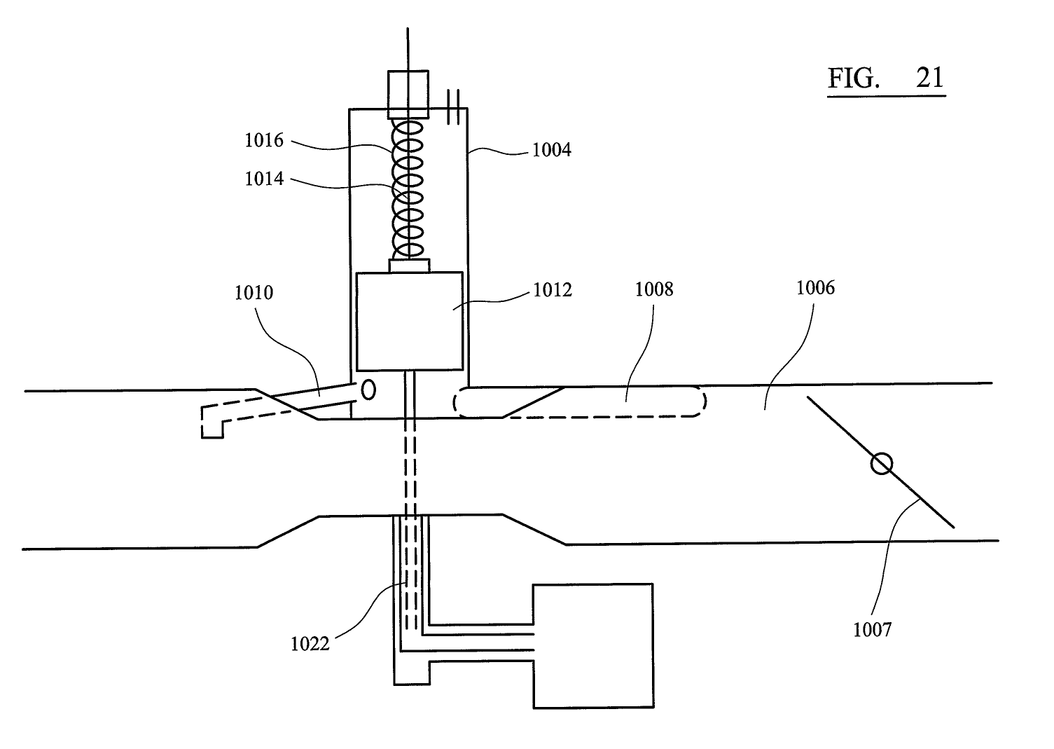

FIG. 22 shows a cross sectional view of an air inlet of the engine;

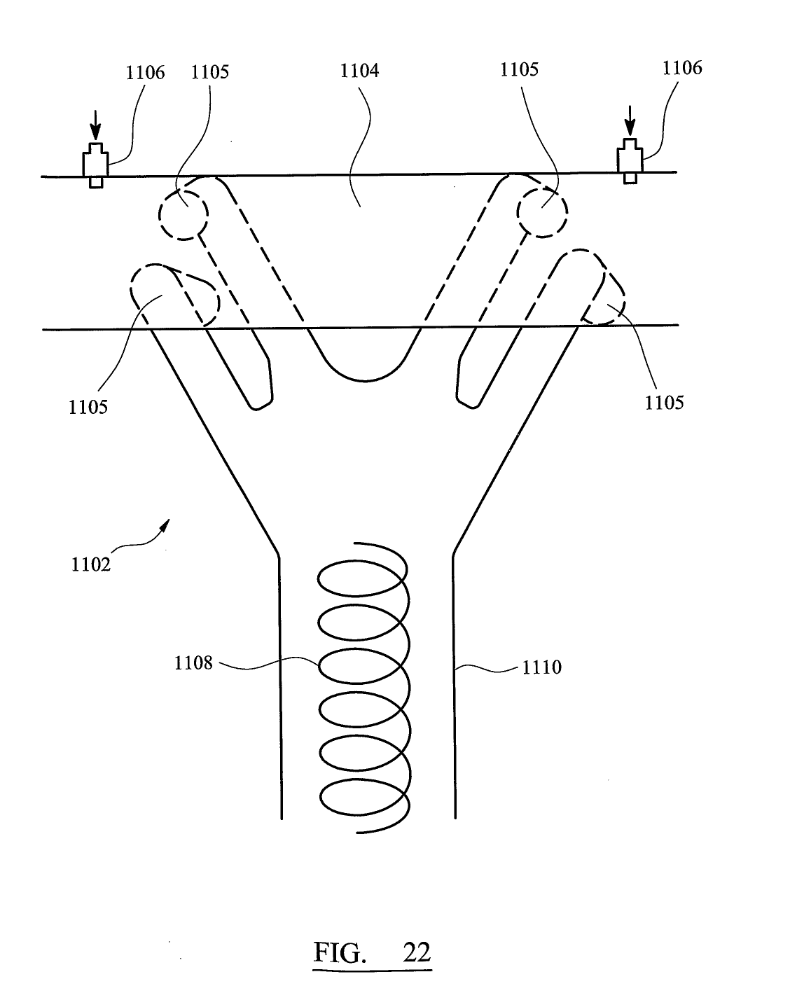

FIG. 23 shows an alternative embodiment of a plan schematic view of a front face of a wall of an engine; and

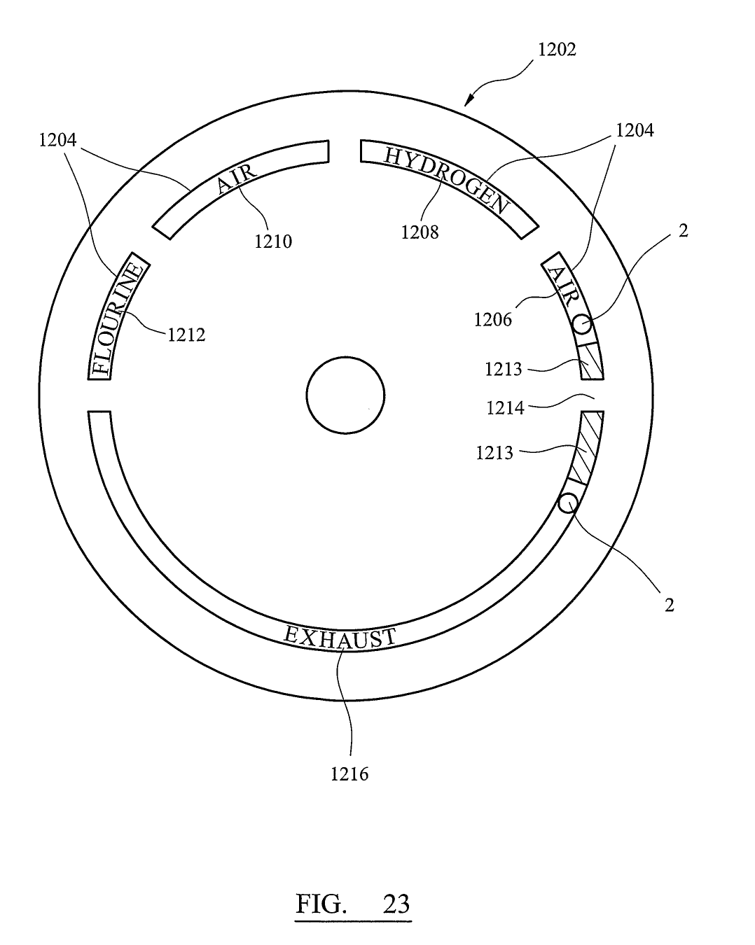

FIG. 24 shows an enlarged exploded view of a lubrication cartridge arrangement of an engine.

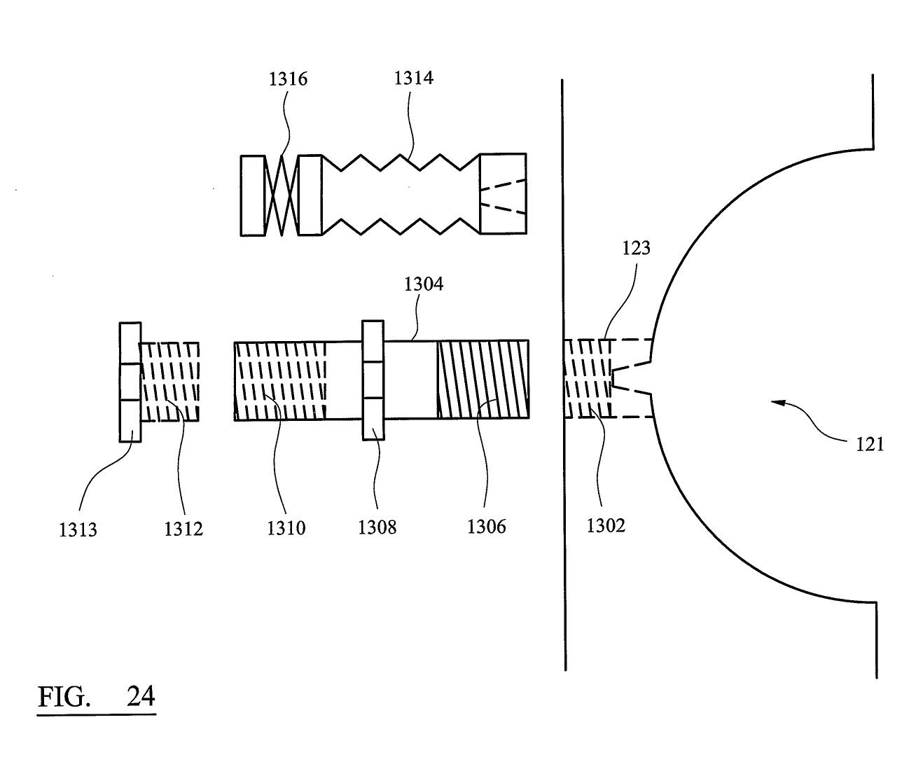

FIG. 25 shows a further aspect of a wheel with an added flange and impeller blades;

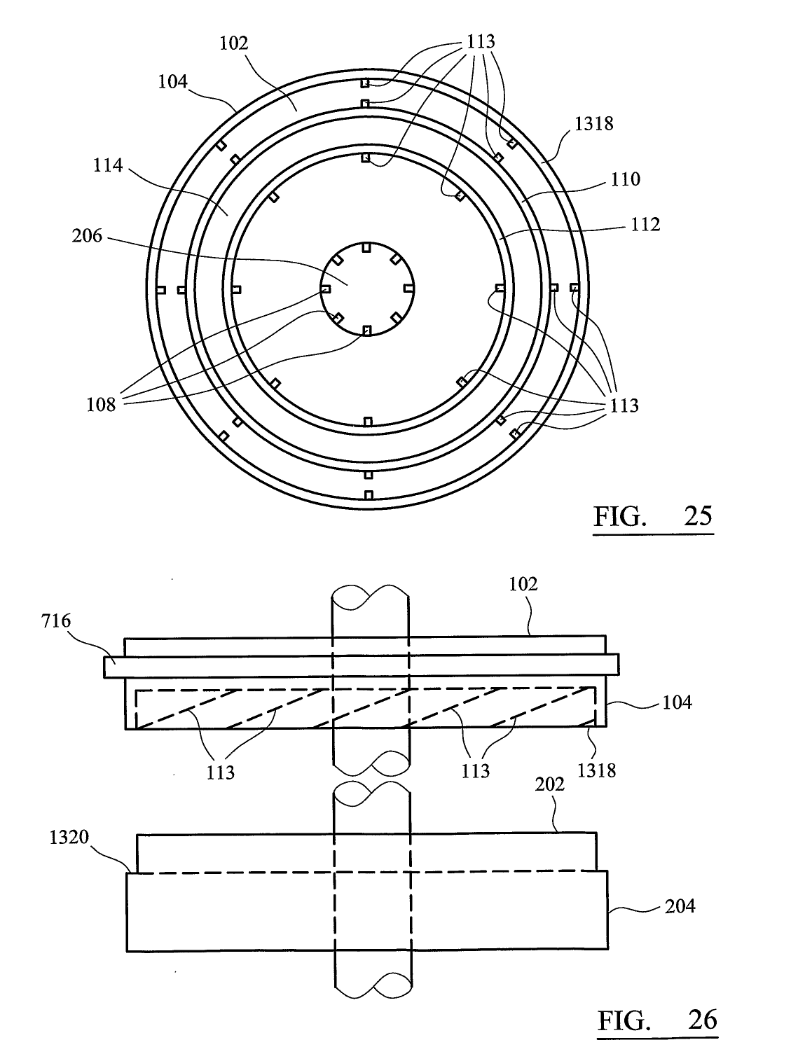

FIG. 26 shows the profile of a wheel and a wall of the engine, showing flange and cutaway;

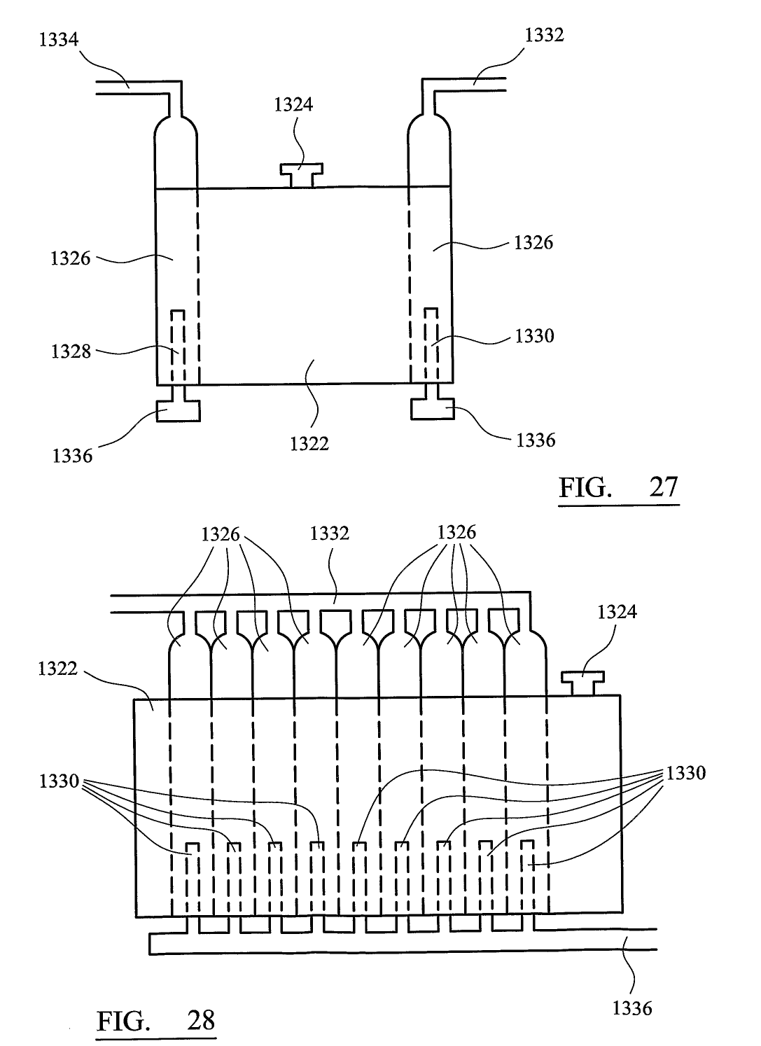

FIG. 27 shows a schematic view of a tank end on; and

FIG. 28 shows a schematic view of a tank side on;

FIG. 1 shows a circular face 102 of a wheel 104. The face 102 has a centrally disposed aperture 106 extending through the wheel 104, the aperture 106 having splines 108 extending longitudinally therethrough to enable the wheel 104 to be splined to a shaft as will be discussed below.

Projecting perpendicularly away from the face 102 are two concentric circular ribs 110, 112. The ribs 110, 112 are also concentric with the aperture 106. The ribs 110, 112 define a circular groove 114 therebetween within which four combustion chambers 116a-d are formed. Each combustion chamber 116 extends the width of the groove and is about 1/12 the length of the groove 114. In other words, the size of each chamber 116 is about 30° of the circular groove 114.

The chambers 116a-d have a constant depth, but may have an internally ramped profile to assist movement of the wheel 104.

In one embodiment (as shown in relation to FIG. 10 and described hereunder) the ignition chambers may protrude through a rear wall of the wheel 104 to facilitate cooling and add cubic capacity to the chambers, if required.

The chambers 116a-d are equally spaced such that their centres are about 90° apart. In between each chamber 116a-d is a raised section 118 having three apertures 120 extending longitudinally therethrough. In use, the apertures 120 may house rolling means such as ball bearings (not shown). Also, behind the ball bearings, that is, within the apertures but distal to the face 102, may be located a lubricant having a spring mounted therebehind to urge the lubricant onto the ball bearing surface.

Inward of the groove 114 are four further apertures 122. The apertures 122 are defined by side walls which are portions of the radius of the circular groove 114 and end walls which are arcuate and are radially separated. Thus the apertures 122 have arcuate end walls. The apertures are equally spaced and situated radially inward of the raised sections 118.

FIG. 2 shows an opposite face 124 of the wheel 104 to that shown in FIG. 1. The aperture 106, splines 108, apertures 120 and apertures 122 are visible on this face because they extend through the wheel 104.

FIG. 3 shows a circular face 202 of a wall 204. The face 202 has a centrally disposed aperture 206 extending through the wall 204. Mounted within the aperture 206 is a collar bearing 208 having the aperture 206 extending longitudinally therethrough.

Projecting perpendicularly inwardly into the face 202 are two concentric circular channels 210, 212 that generally correspond to the projecting circular ribs 110, 112 of the face 102 of the wheel 104. The channels 210, 212 are also concentric with the aperture 206. The channels 210, 212 define a circular path 214 therebetween in which various discrete regions associated with discrete stages of a combustion cycle are located. The path is generally in the form of a semi-circular recess in the wall 204 as shown in FIG. 5.

Following the circular path 214 in a clockwise direction, starting at generally 9 o'clock on FIG. 3, there is shown an air inlet region 216 which extends approximately a quarter of the way around the circular groove (i.e. from about 9 o'clock to about 12 o'clock). The air inlet region 216 comprises an arcuate aperture 218 extending through the wall 204.

A further discrete region is located at approximately 1 o'clock and is a fuel inlet region 220. In the present embodiment, the fuel inlet region 220 comprises a fuel injector 222 which may inject a fuel, for example, petrol. Situated at approximately 2 o'clock is an ignition region 224 which comprises a spark plug 226. The ignition region 224 may comprise more than one spark plug, for example 2, 3, 4 or more spark plugs may be used. The spark plugs may be controlled to fire such that more spark plugs fire as the speed of relative rotation of the wheel and wall increases, for example.

The final discrete region is an exhaust region 228 which comprises an arcuate aperture 230 which starts at just before the 3 o'clock position and extends to just before the 9 o'clock position. The aperture 230 extends just over half way around the circular groove 214 and extends through the wall 204.

FIG. 4 shows an opposite face 232 of the wall 204 shown on FIG. 3. The apertures 218 and 230 are visible because they extend through the wall 204. The opposite face 232 also comprises a wall 234 extending perpendicularly away therefrom which serves to isolate the discrete regions of a combustion cycle. The wall 234 segregates the air inlet region 216 from the other regions by extending radially inwardly at each side of the region 216 and by having first and second inwardly extending sections 236a, 236b joined by arcuate sections 238, 240 at each and thereof. A first arcuate section 238 which joins ends of the sections 236a,b distal to the aperture 206 extends around a section of the circumference of the circular wall 204. A second arcuate section 240 joins ends of the sections 236a,b proximal to the aperture 206 by extending around the aperture 206 while maintaining a constant radius therefrom.

The fuel inlet region 220 and the ignition region 224 are segregated from the other regions by the first of the sections 236a, a portion of the second arcuate section 240 and a further wall 242 extending radially outwardly from the second arcuate section 240.

Finally, the exhaust region 228 is segregated from the other discrete regions by a second of the sections 236b, a portion of the second arcuate section 240 and the wall 242. Also, extending from the second section 236b about 135° around the circumference of the circular wall 204 is a wall 244. The end of the wall 244 distal to the second section 236b and the wall 242 do not meet, thus a gap 246 is formed.

An alternative arrangement of the circular face 202 of the wall 204 is shown in FIG. 23. In this embodiment 1202, the inlet port 1204 is extended and divided into four parts: a scavenging and cooling region 1206, a first fuel inlet region 1208, a second fuel inlet region 1210, and a third fuel/catalyst inlet 1212. As will be appreciated from FIG. 23, the combustion cycle occurs in an anti clockwise arrangement in this embodiment.

In the embodiment shown in FIG. 23, moving anticlockwise from the scavenging and cooling region 1206, as the combustion chamber (shown by crossed lines 1213) spans the spacer 1214 separating the inlet ports 1204 and the exhaust port 1216, a brief blast of air passes through it, cleaning it and cooling it.

The first fuel inlet region 1208 may inlet hydrogen fuel into the chamber, whereafter the second fuel inlet region may inlet air into the chamber. The third fuel/catalyst inlet region may admit a catalyst, such as fluorine, to act as the ignition.

Referring now to FIG. 5 the wheel 104 and the wall 204 are shown in cross-section during assembly. The face 102 opposes the face 202. As can be seen from FIG. 5, the ribs 110, 112 of the wheel 104 are accommodated in the channels 210, 212 of the wall 204 when the wheel 104 and the wall 204 are assembled (by moving them together as indicated by arrow “X” in FIG. 5).

At ends of the ribs 110, 112 distal to the wheel 104 are the edges of impeller blades 113, which will be described in more detail in relation to FIG. 6.

The rolling means, being ball bearings 2, are shown partially accommodated within the sockets 120 of the face 102 of the wheel 104 and partially protruding from the face 102. When the wheel 104 and the wall 204 are assembled (by moving together as indicated by arrow “X”), the part of the ball 2 that protrudes from the face 102 is accommodated in the path 214.

The apertures 120 can be seen to comprise a hemispherical socket portion 121 in which a portion of the ball 2 is accommodated and a tubular portion 123. The tubular portion 123 extends longitudinally through the wheel 104 from within the socket portion 121 to an opposite face (opposite to face 102) of the wheel 104. The tubular portion 123 allows a lubricant (not shown) to be administered to the ball 2.

Referring briefly to FIG. 24, an enlarged exploded view of an embodiment of the lubricant delivery mechanism is shown. The tubular portion 123 comprises a threaded region 1302 at an end thereof distal to the socket portion 121. Into the threaded region 1302 is threaded a removable tube 1304 having an externally threaded first end 1306 to threadedly engage with the threaded region 1302 thereby attaching the tube 1304 to the tubular portion 123. A nut attachment 1308 is provided about the tube 1304 to allow the tube to be tightened.

At an opposite end of the tube 1304 to the threaded region 1306 is an internally threaded portion 1310 operable to threadedly engage with an externally threaded cap 1312 having a bolt head 1313 thereon. In use, a lubrication cartridge 1314 is inserted into the tube 1304. The lubrication cartridge 1314 has a spring 1316 at an end thereof to cause it to be urged toward the socket portion 121.

To remove and replace a lubrication cartridge, the tube 1304 may be removed from the tubular portion 123 by rotation thereof, thus disengaging the threaded regions 1306, 1302.

FIG. 6 shows a side view of the arrangement of the wheel 104 and the wall 204 of FIG. 5 mounted on a shaft. Again, the wheel 104 and wall 204 may be assembled by moving them together as indicated by arrow “Y” in FIG. 6.

On an outer and an inner surface of the ribs 110, 112, that is, faces of the ribs 110, 112 facing inward and outward from the groove 114 are impeller blades 113 extending perpendicularly therefrom. The impeller blades 113 are in the form of fingers that extend diagonally from an edge of the ribs 110, 112 distal to the wheel 104 to an edge of the ribs 110, 112 distal to the wheel 104 to an edge of the ribs 110, 112 proximal to the wheel 104. In use, the wheel 104 rotates relative to the wall 204 and the impeller blades 113 force air through the channels 210, 212 in the circular face of the wall 204 thereby creating an air barrier to prevent leakage and improve the compression in the combustion chambers. In FIG. 6, the wheel 104 has a metal ring extending around a circumference thereof.

Referring now to FIGS. 7a, b and c there is shown three embodiments of a shaft 302a, 302b, 302c being generally circular in cross-section. Referring first to FIG. 7a, there is shown a shaft 302a for use with an engine having a single wheel/wall arrangement. Toward a first end 304a of the shaft 302a there is provided a splined region 306a. Toward the longitudinal centre of the shaft 302a are a plurality of circumferentially spaced longitudinal slots 312a. The slots 312a have parallel side walls that are also parallel with a longitudinal axis of the shaft 302a and rounded end walls.

Situated toward a second end of the shaft 314a is a bearing region 316a that comprises a circumferential groove 318a adapted to house a portion of bearing means (such as ball bearings, for example). This bearing region 316a is housed in a rear wall of an engine and prevents longitudinal movement of the shaft, in use.

Referring now to FIG. 7b, there is shown a shaft 302b for use with an engine having two wheel/wall arrangements, one at either end of the shaft 302b. In this arrangement the shaft 302b does not require a bearing region toward a second end 314b of the shaft 302b.

FIG. 7c shows a shaft 302c for use with an engine having two wheel/wall arrangements, one at either end of the shaft 302c. Further, this shaft 302c is used where the engine does not contain a reciprocating rotor, but receives compressed air from an external source, such as a mechanical compressor. In this regard, the shaft 302c does not require any longitudinal slots, unlike the shafts 302a and 302b.

Referring now to FIG. 8 there is shown a central region of the shaft 302 of FIG. 7 having a reciprocating rotor 402 in the form of a disc 404 mounted thereon by virtue of a central aperture extending through the disc 404. The disc 404 is generally circular in cross-section and has a rim 406 extending around the circumference thereof.

The disc 404 is of a generally constant thickness and has two opposing, undulating faces 408, 410. The undulations are in the form of peaks 412 and troughs 414 that extend radially outwardly from a central region of the disc 404. The disc 404, having a generally constant thickness, has troughs 414 on one face 408 corresponding to peaks 412 on the opposite face 410.

The opposite face 410 comprises a hub 416 surrounding the central aperture of the disc 404, and thus surrounding the shaft 302, which hub 416 has a plurality of rolling means 418 protruding inwardly from a circumferential surface of a circular aperture that extends longitudinally through the hub 416. The rolling means 418 (in this case, ball bearings) extend into the slots 312 of the shaft 302 and thus, while the rotor 402 is constrained to rotate with the shaft 302 along its longitudinal axis, the rolling means 418 are free to roll in the slots thereby facilitating longitudinal movement of the rotor 402 with respect to the shaft 302.

FIG. 8a shows the rotor 402 of FIG. 8 housed in a cylinder 420. The rim 406 extends toward an internal surface 422 of the cylinder 420 such that axial movement of the rotor 402 causes air at each side of the rotor to move.

Referring now to FIG. 9 there is shown a side view of a partially assembled engine 502. Assembled toward a first end of the shaft 302 on the splined region 306 is the wheel 104 having the face 102 facing toward a longitudinal centre of the shaft 302. The splines 108 of the aperture 106 mesh with the splines 302, thus the wheel 104 is constrained to rotate with the shaft 302. Mounted next to the wheel 104 on the shaft 302 is the wall 204 having the face 202 thereof opposing the face 102.

The wall 204 remains static with respect to the rotation of the shaft 302 by virtue of the bearing 208 of the wall 204 being mounted on the bearing region 308 of the shaft.

In this manner, the wheel 104 is constrained to rotate with the shaft 302, but the wall 204 is not. Thus, rotation of the shaft 302 causes relative rotation of the opposed faces 102, 202.

Rotation of the wheel 104 causes the chambers 116 on the face 102 to be exposed to discrete regions of a combustion cycle on the face 202 of the wall 204.

For example, by rotation of the shaft 302, the chamber 116 may be exposed to the air inlet region 216, whereupon air, which may enter the air inlet region through apertures 120 in the wall, is charged into the chamber 116. Clockwise rotation of the wheel causes the chamber 116 to then be exposed to the fuel inlet region 220 which may inject fuel, such as petrol, into the chamber 116. Further clockwise rotation and the chamber 116 (now charged with air and fuel) is exposed to the ignition region which may ignite the fuel/air mix. Further clockwise rotation 116 causes the chamber to be exposed to the exhaust region 228 and thus, the gases released during combustion of the fuel/air may be expelled.

In this manner a combustion cycle within the chamber 116 is completed and by further rotation the process can start again.

Referring again to FIG. 9, the rotor 402 is shown mounted on a side of the shaft 302, proximal to the wall 204. The rotor 402 is housed within a generally tubular housing 504 which extends from the wall 204 and is generally parallel with the shaft 302. As explained above with regard to FIG. 8 the rotor 402 is constrained to rotate with the shaft 302.

In use, a face 408 of the rotor is held at a constant distance from a side wall of the housing 504 by spacing fingers 506 that extend inwardly from the side wall and have bearings 508 at an end thereof that contacts the rotor 402. Thus, rotation of the shaft 302 causes rotation of the rotor 402, which in turn, because of the undulating face of the rotor 402, causes the two chambers defined in the housing at either side of the rotor to grow or shrink by reciprocation of the rotor 402 along the longitudinal axis of the shaft 302.

In this manner, gas may be sucked from or pumped into or out of the discrete regions of a combustion cycle on the wall 204, because apertures 218 and 230 extend through the wall 204.

For example, the timing of the rotor 402 may be adjusted, by which it is meant that the position of the undulations with respect to the chambers 116a-d may be adjusted, such that the rotor moves toward the wall 204 as the chamber 116 is exposed to the air inlet region 216, thus air would be pumped into the chamber by the rotor 402.

It will be appreciated by one skilled in the art that the engine may comprise two or more walls 204 having two or more wheels 104, for example, by reflecting the assembly of the wall 204 and wheel 104 at the opposite side of the shaft 302 to the rotor 402. Also, it will be appreciated that the wheel 104 may have many chambers in the face 102 thereof and that the wall 204 may have discrete regions of more than one combustion cycle thereon. For example, a wheel 104 having sixteen chambers 116 in the face 102 thereof and a wall 204 having discrete regions of four combustion cycles thereon may be constructed in which, one complete rotation of the shaft has sixty four combustion cycles.

Referring now to FIG. 10 there is shown a further embodiment of a wheel 604. The wheel 604 is similar to the wheel 104, but comprises combustion chambers 608 that are deeper than a width of the wheel 604 and thus protrude out of a rear face of the wheel 604. The parts that protrude, ignition chambers 610, are angled outwards and forwards, providing a directional combustion chamber to allow the combustion to drive the wheel in a circular motion. The chambers 608, 610 still define a closed space, because the rear face of the wall 604 comprises protruding regions 610 to accommodate the large chambers 608. The larger chambers 608 facilitate more efficient cooling and increase the cubic capacity of the chambers. A plurality of cooling vanes 606 extending from the protruding ignition chamber 610. The cooling vanes 606 are angled to force the wheel 604 and the wall 204 together, when the wheel 604 rotates relative to the wall. Extending circumferentially around the wheel 604 is a metal ring 716.

Referring now to FIG. 11 there is shown a side partial cutaway view of a second embodiment of an engine 702. The engine 702 comprises two wheel 104 and wall 204 arrangements, one toward each end of a shaft 302, ie. at each side of the engine 702. This embodiment of the engine does not have a reciprocating rotor as described above, but instead has a compressor 704 mounted within the engine housing 706. It will be appreciated that the compressor may equally be situated outside the housing, but in the interest of compactness, in the present embodiment, the compressor is situated inside the housing 706.

The compressor 704 has an outlet pipe 708 which may carry compressed air to the wheel 104 and wall 204 arrangements as described above, by virtue of an inlet 710 which extends through the wall 204. It is also envisaged that the outlet pipe 708 may additionally or alternatively carry other fuels to the combustion chambers, such as, for example petrol, methane, hydrogen, etc.

The compressor 704 may be powered by an external power source such as an electric motor or a petrol or diesel engine, for example. The compressor 704 may derive some or all of its power from the rotation of the shaft 302 by virtue of a belt and pulley arrangement 712 between the compressor 704 and the shaft 302. In one embodiment, the compressor 704 may be driven by two power sources. For example, a first power source such as a motor may drive the compressor 704 when the engine is running slowly, but when the engine is running faster, the compressor 704 may draw its power from the belt and pulley arrangement 712.

Each wheel 104 shown in FIG. 11 has a metal ring 716 extending outwardly from a circumferential edge thereof. At each side of the ring 716 on a base of the engine are electromagnets 714, which in use can be caused to be magnetic thus causing repulsion of the ring 716 and causing the wheels 104 to rotate. IN this manner, the ring 716 and electromagnets 714 provide a starting mechanism for the engine 702. The ring 716 may be insulated from the wheel 104 and may be segmented.

Also shown on FIG. 11 at either side of the engine 702 are stanchions 720 having bearings 718 therein to support and allow rotation of the shaft 302.

Referring now to FIG. 12 there is shown an enlarged view of the junction between the wheel 104 and the wall 204. A ball bearing 2 sits in the socket 120 of the wall, the socket comprising a lubrication channel 123. The ribs 110, 112 can be seen being accommodated in the grooves 210, 212. Also shown are cross sectional views of impeller blades 113 on the ribs 110, 112.

FIG. 13 shows a partially exploded view of the assembly in FIG. 12, with the wheel 104 and the wall 204 being separated. Arrows 722 show the direction of air flow created by the impeller blades 113 when the wheel 104 and wall 204 are in relative motion. An plan view of the coupled assembly is shown in FIG. 14.

Referring now to FIG. 15, there is shown a plan view of a further embodiment of the engine 703. This embodiment clearly shows how an inlet port can be divided into different sections supplied by different compressors 704 delivering different fuels (via fuel pipes 724) to the chambers. The compressors 704 are mounted on a secondary drive shaft 726 which is connected to pulley 712 via a bevel gear 728.

FIG. 16 shows a simplified front view of the engine to exemplify the electromagnetic starting mechanism discussed above with regard to FIG. 11. The electromagnets 714 are situated around the ring 716 and at either side of a lower extent of the wheel 104. In use, a current is fed to the electromagnets 714 causing the wheel 104 to rotate, thus setting in motion the compressor. When the engine is running, the electromagnets 714 are switched off.

Referring now to FIG. 17 there is shown a cross sectional view of compressor 802. The compressor 802 comprises a generally frusto-conical body 804, having a tapered auger 806 mounted on a shaft 808 therein. The shaft is able to rotate on bearings 809. At the top of the frusto-conical body 804 is an inlet 810 which has a propeller 812 splined onto the shaft 808 (and thus constrained to rotate therewith) at the entrance thereto. Surrounding the body 804 is an outer skin 814 that provides a cooling jacket 816 around the body. Toward a top of the body is an inlet 818 operable to allow a gas to inlet therethrough and being controlled by a valve 820. At the bottom of the body is an outlet 822, through which air that has been compressed in the compressor 802 can exit.

FIG. 18 shows a plan view of the compressor 802. In this view, it can be seen that the propeller 812 has four blades: one pair shorter than the other. In use, the larger pair can be used to feed the cooling jacket 816 and the smaller pair to feed the auger 806.

Referring to FIG. 19 there is shown a cross sectional view of an exhaust system 902 of the engine. The exhaust system 902 comprises an outlet 904 in each wall 204, leading to an exhaust pipe 906 via baffles 908 and before exiting the exhaust system 902 via an outlet 910 (after passing through further baffles 912).

There are several ways to deliver fuel into the ignition chambers. Firstly, the fuel could be directly injected as they pass the injection point, followed by air delivered at pressure from the compressor. A heater may be incorporated to facilitate cold starting.

Secondly, fuel could be delivered via a carburettor, which could be situated on the waist of the inlet pipe. A suitable carburettor is shown in FIGS. 20 and 21. A carburettor system 1002 is shown having a cylinder 1004 perpendicularly arranged to an air inlet pipe 1006 of the engine (not shown). Either side of the cylinder 1004 is a conduit 1008, 1010 connecting an upper region of the cylinder 1004 to the inlet pipe 1006. Within an upper region of the cylinder 1004 is a piston 1012 mounted on a rod 1014 and urged downward by a spring 1016. A lower region of the cylinder 1004 contains a further piston 1018 connected by a rod 1020 to the piston 1012. The piston 1018 extends into the inlet pipe 1006 and supports a needle valve 1022. The conduit 1008 has a greater internal bore than the conduit 1010, thus as air flows through the conduit 1008 it increases the internal pressure of the cylinder 1004, thereby causing the pistons 1012, 1018 to lift, thereby lifting the needle valve 1022 and increasing the amount of fuel delivered. As the air inlet pressure is increase (by alteration of the throttle 1007), thus pressure in the cylinder increases thereby opening the needle valve further and increasing the amount of fuel inlet.

In this manner, control of movement of the pistons is achieved by allowing air through the conduit 1008 and out through the conduit 1010.

FIG. 21 shows a similar carburettor system to that shown in FIG. 20 and described above. However, the unit is more compact, thus allowing the conduits 1008, 1010 to be contained within the air inlet 1006, but essentially, the carburettor operates in the same manner.

Referring now to FIG. 22, there is shown a further manner in which to cause air and fuel to enter the ignition chamber. FIG. 22 shows a vortex system 1102 in which the inlet pipe 1104 comprises a number of inlets 1105 arranged around the circumference thereof, thus causing air added through the inlets 1105 (from a secondary air supply pipe 1110, connected to a compressor) to be turbulent and cause a vortex before the fuel is injected into the air stream (via injectors 1106) and into the ignition chambers. A heater 1108 is shown to heat the air, should it be required.

Referring now to FIG. 25 there is shown a further embodiment of the wheel 104 with an added flange 1318 equipped with a further set of impellor blades 113 if needed to further seal the wheel 104 from leakage when it is brought together with the wall 204 FIG. 26 the flange 1318 to encompass the cutaway 1320.

Referring now to FIG. 27 shows the end view of a tank 1322. equipped with open ended containers in it 1326, the left container 1326 having an anode 1328 inserted in it, the right hand container 1326 having a cathode 1330 inserted in it.

Referring now to FIG. 28 shows the side view of a tank 1322. The tank 1322 to be impervious to sulphuric acid and lined inside with columns of open ended containers 1326, alternative lines of containers 1326 to have inserted in them anodes 1328, alternative lines of containers 1326 to have cathodes 1330 inserted in them, the tank 1322 to be filled with acidified water and an electric circuit to be fed to the anodes 1328 and cathodes 1330 from a Hydrogen fuelled engine driving a generator, Oxygen is drawn off from the containers 1326 from the anodes 1328, Hydrogen is drawn off the containers 1326 from the cathodes 1330, the Hydrogen to be fed back to the engine as fuel as part of an ongoing cycle.

An engine made in accordance with the present invention is less complicated, requires less maintenance and has less components than engines known in the art. Further, the wheel is driven around in a constant single direction by combustion in the combustion chambers 116a-d, thus the engine has a high efficiency.

It will be understood by one skilled in the art that the shaft which is constrained to rotate with the wheel 102 represents a power take-off and may therefore be linked to a transmission system in the usual manner and used to drive a variety of machines, for example, vehicles, plant machinery etc.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An engine comprising:
a first section having a first face and a second section having a second face, the first and second faces being opposed to one another and arranged for relative rotation,
the first face comprising at least one chamber,
the second face comprising a plurality of discrete regions each being associated with a discrete stage of a combustion cycle, wherein
the first and second faces are arranged such that relative rotation thereof causes the at least one chamber of the first face to be exposed to the discrete regions of the second face.

2. An engine according to claim 1, wherein the first and second faces are arranged such that relative rotation thereof causes the at least one chamber of the first face to have fluid contact with the discrete regions of the second face.

3. An engine according to claim 1, wherein the two faces are arranged such that relative rotation thereof causes the at least one chamber of the first face to be exposed to the discrete regions of the second face in such an order that a combustion cycle may be completed.

4. (canceled)

5. An engine according to claim 1, wherein each of the plurality of discrete regions includes any one of the following: a first fuel inlet region; a second fuel inlet region; a third fuel inlet region; a compression region; an ignition region; an exhaust region.

6. An engine according to claim 1, wherein the second face comprises at least one fuel inlet region, at least one ignition region and at least one exhaust region.

7. An engine according to claim 1, wherein the discrete regions associated with discrete stages of a combustion cycle are arranged in a generally circular path.

8. (canceled)

9. (canceled)

10. (canceled)

11. An engine according to claim 1, wherein one of the first or second face comprises a generally circular groove.

12. An engine according to claim 11, wherein the other of the first or second face comprises at least one socket.

13. An engine according to claim 12, wherein at least one socket is adapted to allow rolling means to be housed therein.

14. (canceled)

15. (canceled)

16. (canceled)

17. (canceled)

18. (canceled)

19. An engine according to claim 5, wherein the first fuel inlet region may contain means to force a first fuel into the at least one chamber.

20. (canceled)

21. (canceled)

22. (canceled)

23. (canceled)

24. (canceled)

25. (canceled)

26. (canceled)

27. (canceled)

28. (canceled)

29. (canceled)

30. An engine according claim 1, wherein the at least one chamber is a combustion chamber.

31. An engine according to claim 1, wherein the engine is a combustion engine.

32. A machine or vehicle comprising an engine according to claim 1.

33. An engine having a rotor with at least one combustion chamber, wherein the rotor is adapted to rotate with respect to a body section, said body section providing, in use, discrete regions for performing stages of a combustion cycle in cooperation with the rotor.

34. (canceled)

35. (canceled)

36. (canceled)

37. (canceled)

38. (canceled)

39. (canceled)

40. (canceled)

41. (canceled)

42. (canceled)
